(19) United States
(12) Patent Application Publication
(10) Pub. No.: US 2004/0181327 A1
(43) Pub. Date: Sep. 16, 2004

(54) Vehicle security through an automatic control system

(76) Inventor: Everett K. Tsosie, Albuquerque, NM (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/387,176

(22) Filed: Mar. 11, 2003

(51) Int. Cl. G06F 7/00

(52) U.S. Cl. 701/36; 340/5.8; 307/10.2

(57) ABSTRACT

A vehicle security subsystem embedded within an automatic control system for granting secure access to a valid operator and denying access to an invalid operator even if the vehicle is in operation. The security subsystem communicates valid operator conditions to other subsystems through a verification system. If not verified, this system communicates an invalid operator condition to other subsystems to actuate predetermined operational conditions depending on sensors for in-operational or non-operational conditions. If in-operational conditions exist and an invalid operator condition exists, the vehicle can retain current operational conditions but will limit or ignore operator requests or retain current operational conditions and ignore commands by the invalid operator and bring vehicle to a safe shut down state. If an invalid operator is detected prior to operation, the vehicle immediately locks down and requests re-verification or will shut down if in startup mode. The system can also include a backup system.

### BACKGROUND OF THE INVENTION

1. Field of the Invention (Technical Field):

This invention relates to security systems and more particularly to a method and apparatus for maintaining a secure vehicle through subsystem communications of a valid operator.

2. Background Art

Vehicle security is paramount after the recent terrorist attacks, especially in commercial aircraft. Anyone with some operational knowledge of an aircraft can start an aircraft and take off. Additionally, while the aircraft is in-flight, the aircraft is in danger from hostile passengers. The present invention provides a way for the aircraft to lock out an invalid operator. In the past, aircraft did not have security systems due to the complexity of early aircraft. Today's, aircraft are built smarter with less flight controls and more automation so the inclusion of security systems is now possible. Although the discussion herein deals primarily with aircraft security, the problems of an invalid operator can also exist on other types of land and water bourn vehicles. The present invention is applicable to the operation of these vehicles as well.

There are several prior art devices that consist of an interlock to prevent an invalid operator from starting a vehicle. However, none of the prior art devices provide a system to operate in a predetermined safe manner when an invalid operator tries to maneuver the vehicle during transport or operation. Some of these prior art devices are set out below.

U.S. Pat. No. 5,917,405, entitled Control Apparatus and Methods for Vehicles, describes a security control apparatus for an automotive vehicle with more than one control device, of which one is remote from the vehicle. This control apparatus is a on or off switch for the vehicle which assumes that the operator wants to gain entry by either a control device on the vehicle or a control device that transmits the access to the vehicle. This does not provide a solution while the vehicle is being operated.

U.S. Pat. No. 5,986,543, entitled Programmable Vehicle Monitoring and Security System Having Multiple Access Verification Devices, uses a two-way communication with a central monitoring station and security devices like auto-theft. This does not provide a solution to the security method and how the other systems will respond.

U.S. Pat. No. 6,373,950, entitled System, Method and Article of Manufacture for Transmitting Messages Within Messages, utilizing an extensible, flexible architecture describes a security communication protocol. This does not provide a solution to the security method and how the other systems will respond.

U.S. Pat. No. 5,301,247, entitled Method for Ensuring Secure Communications, describes a secure communication system. The shortcoming of this patent is that it does not provide for safety measures during flight.

U.S. Pat. No. 6,353,779, entitled Method for Managing Communication Modes for an Aircraft describes a network selection for transmitting data to ground-stations. This disadvantage here is that the vehicle is not secure. This system only allows a monitoring of the events that occur.

The intent of most security systems is to prevent access to a vehicle by locking the controls of the vehicle in the vehicle. In the present invention, the operator will not be prevented access to the controls, but will make the control non-responsive to the operator. Most security systems will not prevent unauthorized access to the controls if the vehicle is in use or idled. This invention takes this in account by continuously letting the system know whether the operator is valid while in operation or idled. In the event the operator detects a threat, they can quickly invalidate the operator while the vehicle is in motion or idled. This invention will provide control commands to the automatic controls directly or indirectly to safeguard the vehicle and occupants.

The state of the art approaches failed to solve the problem of in flight or in operation vehicle security. They fail to address a situation where the pilot or operator (invalid operator) could be the potential threat to the aircraft or vehicle. Additionally, the prior art systems simply do not allow the invalid operator access to the vehicle or disable the starting mechanism. The present system is preferably embedded in the control mechanisms and creates a novel solution, which allows subsystem developers to make the decision of how the systems will respond.

### SUMMARY OF THE INVENTION (DISCLOSURE OF THE INVENTION)

In accordance with the present invention, there is provided an automatic control system for vehicle security for controlling access to the vehicle by an operator during a plurality of different stages of operation of the vehicle comprising an operator validity apparatus, at least one sensor for determining a stage of operation, from the plurality of stages, of the vehicle and a vehicle control apparatus for controlling predetermined functions of the vehicle based on outputs from the operator validity apparatus and the stage of operation. The preferred operator validity apparatus comprises a member from the group consisting of a code entry apparatus, a fingerprint recognition apparatus, a voice recognition apparatus and an eye imaging apparatus. The operator validity apparatus can also comprise periodic prompts to request an operator validity update. The periodic prompts can comprise periodic prompts when an operator is invalidated. The operator validity apparatus can also comprise prompts to request an operator validity update upon performance or non-performance of predetermined maneuvers. The preferred at least one sensor comprises operational sensors. The preferred at least one sensor also comprises environmental sensors. The stages of operation comprise a member from the group comprising of vehicle off, vehicle on but not moving, vehicle on and moving, vehicle on and a predetermined function is attempted by the operator and vehicle on and after predetermined time periods. The preferred vehicle control apparatus for controlling predetermined functions comprises an apparatus for automatically triggering a predetermined sequence of controls of the vehicle.

The preferred method for controlling access to a vehicle by an invalid operator during a plurality of different stages of operation of the vehicle comprises the steps of validating the operator, sensing an operational status of the vehicle comprising the plurality of different stages of operation of the vehicle and controlling predetermined functions of the vehicle if the operator is determined to be invalid and based on a stage of operation, from the plurality of stages of operation, of the vehicle. The preferred method further comprises the step of periodically prompting an operator validity update. The step of periodically prompting preferably comprises periodically prompting when the operator is invalidated. The method can further comprise the step of requesting an

operator validity update upon performance or non-performance of predetermined vehicle maneuvers. The preferred step of validating the operator comprises a member from the group consisting of an active validation procedure, a passive validation procedure and a combination active/passive procedure. The preferred step of sensing an operational status comprises sensing environmental conditions. The preferred step of sensing an operational status comprises sensing vehicle operational conditions. The preferred step of controlling predetermined functions of the vehicle comprises automatically triggering a predetermined sequence of controls of the vehicle.

A primary object of the present invention is to provide a system that safely removes control from an invalid operator.

Another object of the present invention is to provide different internal options to control the vehicle depending on whether the vehicle is in operation or in a start up mode.

Yet another object of the present invention is the ability to secure and override the vehicle's navigational systems when an invalid operator is discovered, especially while the vehicle is in operation.

One advantage of the invention is that it provides security in vehicles with automatic controls by providing a method to stop the vehicle, if in motion.

Another advantage of the invention is it is directly integrated with an automatic control system, thus not requiring any encryption technology.

A further advantage of the invention is that is provides a triggering point, whereby a proper action can be implemented when an invalid operator is discovered.

Yet another advantage of the invention is that it is a closed system, which requires no external hardware to function properly.

Yet another advantage of the invention is that it can readily interact with other modules and requires little modification to the modules to accept messages from the present invention.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 depicts the preferred system security interface with vehicle operational systems.

FIG. 2 is a flow chart of the logic control of the automatically controlled system for determining a valid operator.

FIG. 3 is a flow chart showing a typical logic activation scheme for a aircraft system.

FIG. 4 shows a logic diagram for a backup system for the automatically controlled security system.

### DESCRIPTION OF THE PREFERRED EMBODIMENTS (BEST MODES FOR CARRYING OUT THE INVENTION)

The present invention is a system that provides a safeguard in two situations. First, is a system that provides a protocol if an invalid operator is determined at startup. The second situation provides a system to determine if an invalid operator is controlling the vehicle (in operation), and if he/she is determined to be an invalid operator to automatically control predetermined functions of the vehicle that cannot be overridden by the invalid operator. The preferred components for the present invention comprise an interface to an existing or installed automated control system.

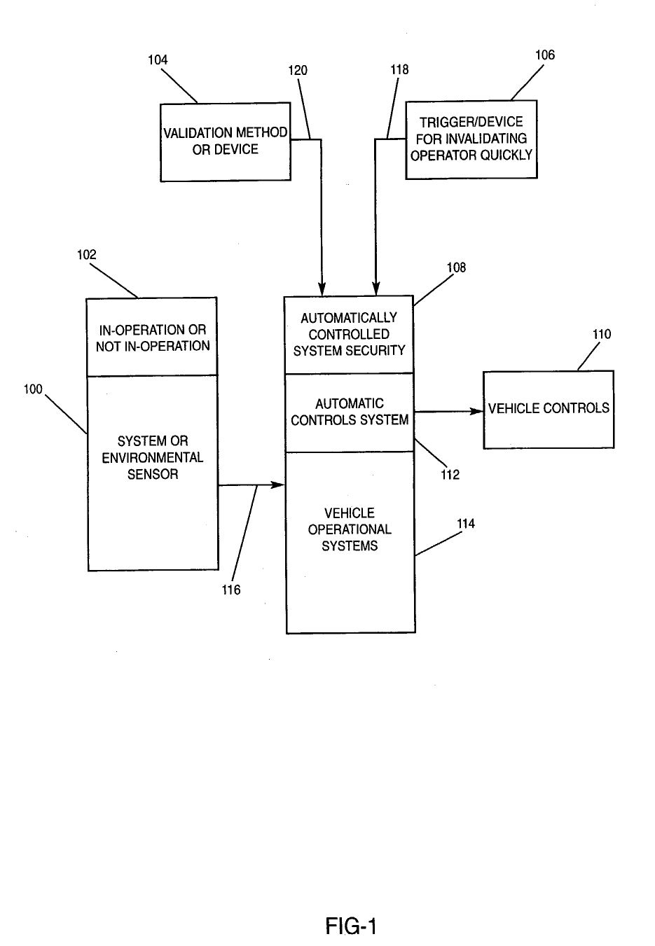

FIG. 1 shows the preferred system security interface with vehicle operational systems and shows the data flow between modules, sensors, and other devices. The physical elements may be integrated with other functionalities on one or more modules or be a self-standing system. This invention can be made as an independent module in any type of modular unit, which provides functionality to the vehicle. Security module 108 receives data from operational sensors 102 that determine if the vehicle is in operation or not in operation, receives information of what is available in the modular unit, and determines security access from the operator. Validation method/device 104 provides an output that indicates if the operator is valid or not. Validation method/device 104 can comprise an active type procedure where the operator has to perform a function, a passive procedure where the procedure is performed automatically or a combination of the two. Examples of validation procedures are entered codes, fingerprints, voice recognition, eye images, or other known devices or methods well known in the art. There are many different ways to describe an invalid operator. These include, but are not limited to: a person not trained in operating the vehicle; a person entering an unattended vehicle; a person that is forced to take control of a vehicle; a person that has purposely taken control of the vehicle for any reason; or a situation where the operator becomes unresponsive or unavailable for any reason.

If the vehicle is not in operation with an invalid operator, the module will provide an output that will shutdown the vehicle or will start a sequence of events to shutdown the vehicle. If the vehicle is in operation with an invalid operator, automatically controlled system security module 108 provides commands that will place the vehicle in a shutdown state or quasi-operational state, to safely bring the vehicle to a stop.

When the vehicle starts up or restarts, the system will request a valid operator prompt from an entry location or device 104. By default, the operator is invalid and in non-operational mode. When operator is validated and in non-operational mode, the other modules will start responding to normal operator commanded operations. In the alternative, all modules can power up, but will not respond to operator requests until validated. In the event an invalid operator is detected, the operator can reenter validation information; however, after a predetermined number of attempts or the absence of the module, all modules will begin to power down or be placed in a state of inactivity.

When the vehicle is in-operation, the system can periodically send out a valid operator prompt to continuously question if the operator is valid. In the alternative, the operator may receive prompts to validate on the activation of certain operations, such as accelerate, open landing gear, deviate from flight plan, or other predetermined operations. The system can also have a triggering method or device for quickly invalidating the operator of the vehicle. If this event is triggered, the module will immediately start sending out an indication of an invalid operator by failing to enter correct security access. To regain access, the operator must be re-validated through the verification device.

When in operation, if automatic controls are not engaged (invalid operator), the module will start engagement, place the vehicle on a predetermined course and ignore operator requests. If automatic controls are engaged, the module will ignore operator requests. If operator becomes invalid during a transition from in-operation to not in-operation or vice-versa, then the system will continue the transition. After the transition from in-operation to not in-operation, the module will continue lock down. Regardless, the system will ignore operator requests.

As shown in FIG. 1, environmental sensors 100 and operational sensors 102 provide sensor data, while automatically controlled system security module 108, automatic control systems module 112, and vehicle operational control systems module 114 are preferably located within a modular unit. Automatically controlled system security module 108, automatic control systems module 112 and vehicle operational control systems module 114 are part of the modular unit and have direct access to each other's data through a common data bus (not shown). The interaction between the sensor data and the modular units is accomplished with physical connections or data bus 116. Validation method/device 104 is connected to automatically controlled system security module 108 by a first connector data cable 118, or the like. Trigger/device 106 is connected to automatically controlled system security module 108 by a second data cable 120. The functional connection between automatically controlled system security module 108 to vehicle controls 110 is via automatic control systems module 112 commands. Correction data to control the vehicle is sent to automatic control systems module 112, which will send the required commands to vehicle controls 110. Automatic control systems module 112 makes the physical changes to the vehicle as directed by automatically controlled system security module 108. Operational sensors 102 and/or environmental sensors 100 monitor these physical changes.

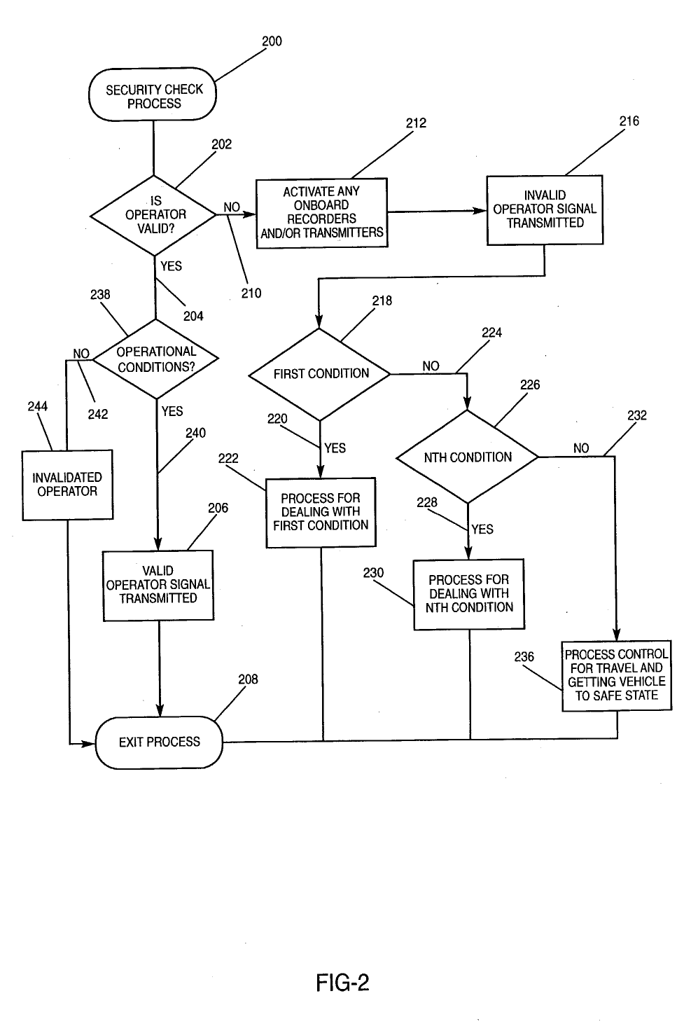

FIG. 2 is a flow diagram of the preferred automatically controlled security system for determining a valid operator. The process begins with start or security check process 200. The next step is operator validation 202 using the methods described above. If the operator is valid 204, and vehicle is determined affirmatively 240 to be in a safe operational condition 238, the system will transmit a valid operator signal 206 and the system will exit the process 208. If the operator is valid 204, and vehicle is not in safe operational condition 242, the system will transmit an invalid operator signal 244 and the system will exit the process 208. If the result of the operator validation step 202 is not valid 210, several functions can be activated or deactivated, such as activating onboard recorders and/or transmitters 212, and transmit an invalid operator signal 216. Once these functions are activated or deactivated, the system reviews the first operational condition 218 of the vehicle. This first operational condition 218 can be vehicle off (not started) or vehicle engine on but vehicle not moving or any initial condition chosen as a starting point for validation. The vehicle operational condition is determined by the sensors as previously described. If the first operational condition 218 is met 220, a predetermined sequence of activities or process for dealing with the first condition 222 are employed. The system then exits the process 208. If the first condition 218 is not met 224 because the vehicle is started, moving or in flight (again depending on the chosen condition) the system proceeds to the nth condition 226, to determine if the nth conditions 228 are met. Although only three operational conditions are shown, there can be more or less conditions included depending on the designer's preference and the type of vehicle. If the nth conditions are met 228, the predetermined process for dealing with the conditions 230 are employed and the system exits the process 208. If the system does not meet 232 the nth condition 226, the system proceeds to the default condition where predetermined process are controlled to get the vehicle to a safe state 236. This can include placing the vehicle in autopilot or an autoland sequence, or bringing the vehicle to a safe stop, again depending on the designer's preference and the type of vehicle. Once the controlling processes 236 are activated the systems exits the process 208.

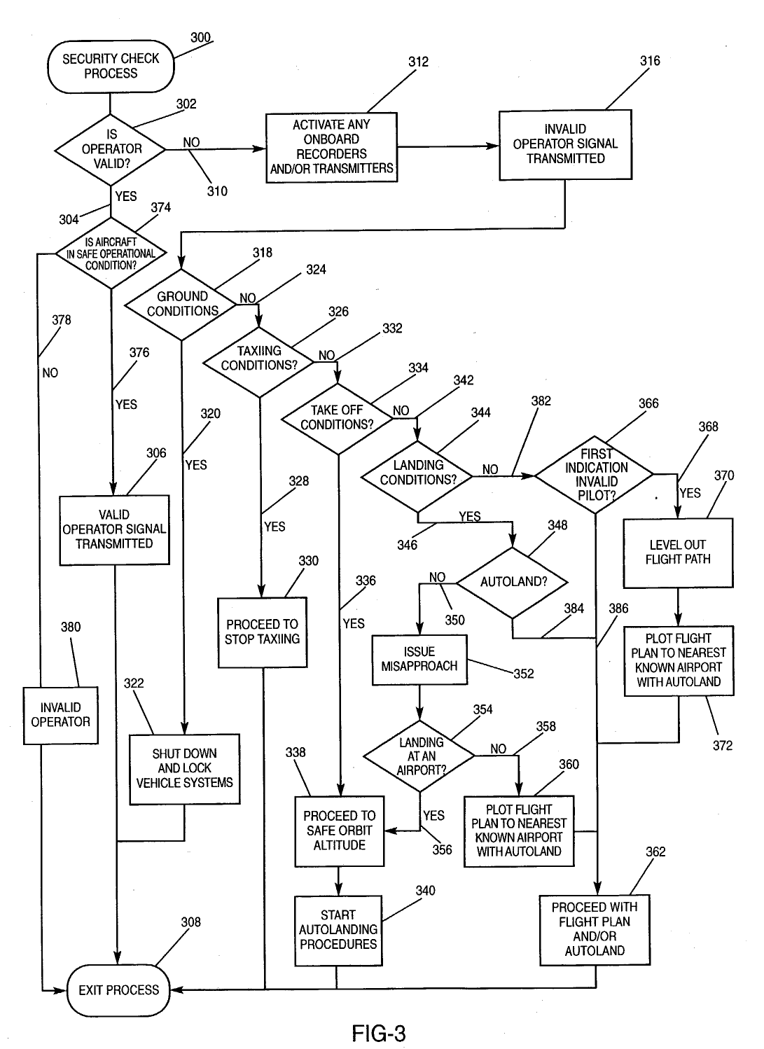

FIG. 3 is a flow chart showing a typical logic activation scheme for the present invention in an aircraft system. This flow chart is generally similar to FIG. 2, however it is tailored specifically for an aircraft system. The process begins by starting the security check process 300. The first step is the operator validation process 302 using apparatuses as previously described. The validation request 302 can be made upon the occurrence or non-occurrence of events or upon periodic prompts. If the operator is valid 304, the next step is to determine whether the aircraft is in safe operational condition 374. If the determination is affirmative 376, the system will transmit a valid operator signal 306 and the system will exit the process 308.

If the operator is valid 304 and aircraft is determined to not be in safe operational condition 378, the system will transmit an invalid operator signal 380 and the system will exit the process 308. If the operator is not validated 310, the system will activate or deactivate certain function in the aircraft, such as activating onboard recorders and/or transmitters 312, and transmit an invalid operator signal 316. Next, the system will check ground conditions 318, to determine that the aircraft is on the ground and not moving. If these conditions are met 320, the system will shut down and lock the vehicle systems 322 and exits the process 308. If the ground conditions 318 are not met 324, the system queries the sensors to determine whether taxi conditions 326 are met. If the answer is affirmative 328, the system will override the vehicle controls and proceed to stop the plane from taxiing 330 and exit the process 308.

If the taxi conditions are not met 332, the sensor information determines whether take off conditions 334 are met. If the answer is affirmative 336, the controls are overridden and the vehicle is instructed to proceed to a safe orbit or pattern altitude 338 and the system starts autoland procedures 340. The process then is exited 308. If the take off conditions are not met 342, the sensor information determines whether landing conditions 344 are met. If the answer is affirmative 346, the controls processing decision is based upon whether the operator or autoland procedure 348 has the current control condition. If landing conditions are met 346 and the operator has the current control and autoland is not activated 350 and landing at a known airport 354 is determined to be possible 356, the controls are overridden and the vehicle is instructed to execute a misapproach 352 and proceed to a safe or pattern altitude 338 and the start autoland procedures 340. The system then exits the process 308.

If landing conditions 344 exist 346 and the operator has the current control (not in autoland) 350 and landing at a known airport is not possible 358, the controls are overridden and the vehicle is instructed to execute a misapproach 352, proceed to a known airport 360, and proceed with flight plan and autoland 362. The system then exits the process 308.

If landing conditions 344 exist 346 and the autoland procedures 348 has the current control 384, the controls are overridden, if not already and proceed with flight plan and autoland 362 and the process is exited 308.

If the landing conditions 344 are not met 382, the sensor information determines whether this is the first indication of an invalid pilot 366. If the answer is affirmative 368, which indicates that the trigger event just happened in normal flight, the controls are overridden and the aircraft proceeds to level the aircraft out at current flight level 370 and is provided a solution to the nearest known airport with autoland procedures 372 and proceeds with flight plan and autoland 362 and the process is exited 308. If the first indication of invalid pilot is not met 386, the controls are overridden, if not already, and the aircraft will proceed with flight plan and autoland 362 and exits the process 308.

The preferred embodiment of the invention is in mobile vehicles with automatically controlled systems. The present invention provides direct interface with the control system without requiring data formatting or signal converting. If the system consists of a planning system that affects direction, orientation, speed and/or acceleration based upon time intervals and duration, this system will interface with that unit to control the vehicle. The present invention can also interface with other modules that interface with the operator. The input interface to the invention comprises sensor data, which will help determine if the vehicle is in operation or not in operation.

One of the unique features of the present invention is the ability to automatically control the vehicle while in motion when an invalid operator is detected. There are several options that can be included in the present system. They include but are not limited to: controlling the vehicle while a valid operator is not available; controlling the vehicle's path and motion to a destination determined by an authorized third party; creating pathways for vehicles to follow automatically, which can be duplicated among several vehicles; creating a programmable vehicle by heading and speed control based upon external factors; and creating an integrated circuit part of the vehicle's automatic control system.

The system can also have a backup system, which can be another module installed in another modular unit, which is used as a backup. If the module is used as a backup, it will remain in monitoring mode of the other module, which is sending a module status to the backup. If backup detects a bad primary module and other subsystems are requesting data, the backup will take over. If the primary module restarts or starts up, it will determine if the backup module is in control. If backup is in control, the primary will take its place as backup. Thus, backup becomes primary, and primary becomes backup. A specific feature of the invention's process is that it can act as a backup or the primary security module.

The role of backup is monitoring the primary unit's outputs and the other module requests (if any). It also monitors the validation method or device 104 and trigger/device 120 for invalidating the operator quickly and to verify that the primary is reacting correctly. If primary is deemed non-responsive, shutdown or placement in non-active mode of module will commence.

It is possible to have more than two units. If more than two modules are installed any additional units will remain in standby mode until either primary or backup stop responding. If that happens the non-responsive unit will be placed in non-active mode or shutdown.

If only one modular unit exists, it is possible to install two security modules in the same unit, and will maintain the primary and backup setup. The preferred embodiment comprises a backup, due to a possibility of failure of a single modular unit.

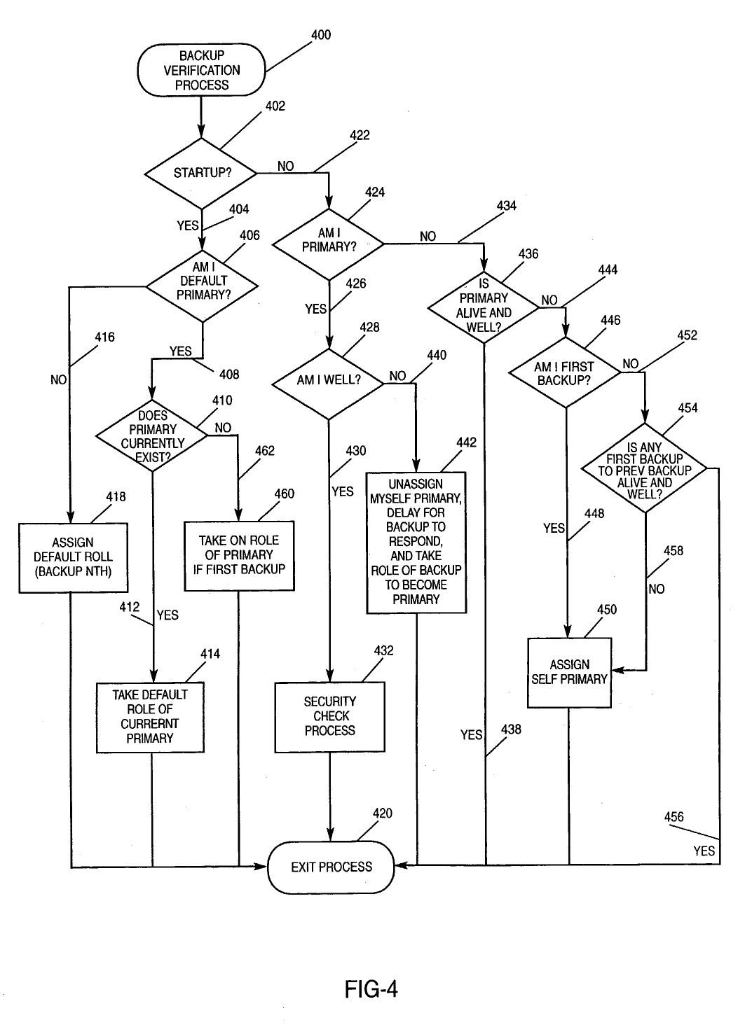

FIG. 4 shows a logic diagram for a backup system for the automatically controlled security system. The process begins with start or backup verification process 400. The next step is startup verification 402. If module startup 402 is indicated 404 and the current security system is not the 416 defaulted primary 406, the security module is assigned its default backup position 418.

If module startup 402 is indicated 404, the current security system is determined 408 to be the default primary 406, and a determination is made 412 that the primary exists 410, the security module takes a backup position of the security module that is current primary 414 and exit the process 420.

If module startup 402 is indicated 404, the current security system is the default primary 406, and a determination is made primary does not exist 462, the security module takes on primary role if 1^{st} backup 460 and exit the process 420.

If module startup 402 is not indicated 422, the module will determine if it is primary module 424. If it is primary module 426, it will determine if the primary module is well and alive 428. If it is well 430, the module will proceed with the security check process 432 and exit the process 420.

If module startup is not indicated 422, the module will determine if it is primary module 424. If it is determined to be the primary module 426, it will determine if it is well 428. If it is not well 440, the module will be unassigned as primary 442, wait a specified amount of time for a backup to take on the role. When the backup is assigned the module will take its place in the backup sequence. If time out occurs, the primary will remain primary with the invalid data 442 and exit the process 420.

If module startup 402 is not indicated 422, the module will determine if it is primary module 424. If it is determined not to be the primary module 434, it will determine if the primary is alive and well 436. If primary is alive and well 438, then the system will maintain the status quo and exit the process 420.

If module startup 402 is not indicated 422, the module will determine if it is primary module 424. If it is determined that it is not the primary module 434, it will determine if the primary is alive and well 436. If primary is not alive and well 444, the module will determine if it is the first back up 446. If it is the first backup 448, then the module will assign itself primary 450 and exit the process 420.

If module startup 402 is not indicated 422, the module will determine if it is the primary module 424. If it is not primary module 434, it will determine if the primary is alive and well 436. If primary is not alive and well 444, the module will determine it if is the first backup 446. If it is not the first backup 452, then it will determine if any prior backups were alive and well 454. If any alive and well prior backups do not exist 458, then the module will assign itself primary 450 and exit the process 420. If there are any backups alive and well 456, the system will maintain the status quo and exit the process 420.

Most security systems are stand alone systems. By embedding the security in the control system, this prevents the need for message encryption and commands, and provides a decision making point for the system to determine if an operator is valid or not. Once the decision is made that the operator is invalid, the control mechanisms in the present invention are activated. The control mechanisms can be custom designed for each type of vehicle or use.

The software programming can be any language that can handle data input. It is preferred to use C, ADA or any other scientific programming software. The security and communication algorithm can be commercially available or described in any public literature.

The vehicle controls 110 can comprise actuators, servo motor, stepper motors, fans, robotics systems, engines, generators, bridges, conveyor belts, grain refineries, HAV systems, turbines, etc. Commercial applications of this invention can be in aircraft (military or commercial), trains (combustible or electric), ship, ocean liners, large construction vehicles, cranes, and/or land vehicles.

### INDUSTRIAL APPLICABILITY

The invention is further illustrated by the following non-limiting examples.

### EXAMPLE I

The following examples include scenarios for aircraft wherein normal flight is defined as taxi/takeoff, climb, flight level, descent, deceleration to approach/landing. Each of the examples represents different stages of operation of the respective vehicle and the resulting functions that are controlled by the invention, depending on the stage of operation and a determination of whether the operator is valid or invalid.

A. No Incident Flight Situation.

During the operation of the aircraft the invention will maintain a monitoring mode. If no incident is captured, the invention will not interrupt the normal operation of the aircraft.

B. Incident on Ground Prior to Startup.

If there is an incident prior to startup of aircraft and is in a parked state where wheels are not moving, the system will require the pilot and copilot (if applicable) to properly identify themselves through validation method/device 104. When the pilot or copilot (if applicable) is not validated, the invention will issue an invalid operator and lock out further attempts. Other modules that depend upon a valid operation will continue to power up and wait for a valid operator. If the valid operator is not detected after a specified amount of time the module will shutdown. At this state, the vehicle becomes inoperable and requires a complete restart of all systems.

C. Incident while Aircraft is Taxiing.

If there is an incident while the aircraft is taxiing, but not in takeoff mode, the module will detect an invalid operator through the trigger/device 106. When this is detected, the system will immediately issue an invalid operation prompt. If this invention is tied to the onboard recorder or transmitters, the invalid operator signal will trigger such device to activate. If this invention is tied to the Automatic Controls Systems (ACS) and the ACS has programmed automatic landing, the invention's invalid operator signal will command the ACS to stop the aircraft. When the aircraft stops, which is defined as the point where the wheels stop turning and there is weight on wheels (WOW), the aircraft control modules will shut down.

D. Incident while Aircraft is Taking Off.

If there is an incident while the aircraft is taking off, the module will detect this through the trigger/device for invalidating operator 106. When this is detected, the system immediately issues an invalid operator signal. If this invention is tied to the onboard recorder or transmitters, its invalid operator signal will trigger such devices to activate. If this invention is tied to the ACS and the ACS has programmed automatic landing, the ACS will continue climb to a safe altitude for a safe landing. At this time, operator commands will be invalid, which will prevent commanding the vehicle manually. If the operator becomes valid during this time, control of the aircraft will be given back to operator. If not, the aircraft will start the autoland sequence. If the aircraft is equipped with fuel injection functions, these will automatically activate if the altitude is sufficient. If the operator becomes valid during the autoland sequence, autoland will continue but will only provide misapproach functionality to the operator. If the operator remains invalid, the aircraft will land. When the aircraft stops, the aircraft controls modules will shut down. Other modules, which depend upon the operator validity, will also shutdown.

E. Incident while aircraft is in climb, flight level, descent or deceleration.

If there is an incident while the aircraft is in any stage of flight, the module will detect this through the trigger/device for invalidating operator 106. When the invention detects this event, it will immediately issue an invalid operator signal. If this invention is tied to the onboard recorder or transmitters, its invalid operator signal will trigger such devices to activate. If this invention is tied to the ACS and the ACS has programmed automatic landing, the ACS will stop climb, descent, or deceleration and maintain a level flight. If this invention is tied to a Flight Management System (FMS), this system will find the nearest airports in the database and provide solutions for landing at the prescribed airport if the operator is invalidated. The ACS will control the aircraft to make an automatic landing at the prescribed landing site.

F. Incident while Aircraft is Landing at an Airport.

If there is an incident while the aircraft is landing, the module will detect this through the trigger/device for invalidating operator 106. When the invention detects this event, it will immediately issue an invalid operator signal. If this invention is tied to the onboard recorder or transmitter, its invalid operator signal will trigger such devices to activate. If this invention is tied to an ACS and the ACS has programmed automatic landing, the ACS will stop landing and issue a misapproach. If this invention is tied to a FMS system, its invalid operator signal will activate a FMS misapproach flight plan. The ACS will receive new flight commands from the FMS system and will start the autoland sequence.

G. Incident while Aircraft is Landing not at an Airport.

If there is an incident while the aircraft is landing, the system will require the operator to properly identify himself through the validation method/device 104 through the trigger/device for invalidating operator 106. If the operator is determined to be an invalid operator, the system will immediately issue an invalid operator signal. If this invention is tied to the onboard recorder or transmitter, its invalid operator signal will trigger such devices to activate. If this invention is tied to an ACS and the ACS has programmed automatic landing, the ACS will stop landing and issue a misapproach. If this invention is tied to a FMS system, its invalid operator signal will activate a FMS misapproach flight plan. If the FMS cannot find a programmed misapproach or landing sequence for the aircraft location, the FMS will plot a course to the nearest prescribed airport. The ACS will receive new flight commands from the FMS system and will start on the new heading. When in airport airspace, the autoland sequence will start.

### EXAMPLE II

The following examples include scenarios for semi or tractor-truck scenarios where normal operation of vehicle is defined as idle or 1^{st} gear through nth gear. The ranges for control depend upon the set gear, engine throttle, and weight of cab and cargo. The speed and acceleration are dependent upon these conditions. Another condition is the traveling surface inclination and the road curves, as well as the type of controls installed on the vehicles, which can include engine brakes, trailer brakes, and number of axles.

A. No Incident Travel Situation.

During the operation of the vehicle the invention will maintain a monitoring mode. If no incident is captured, the invention will not interrupt the normal operation of the vehicle.

B. Incident on Level Ground Prior to Startup.

If there is an incident prior to startup of the truck or truck is in parked stated where wheels are not moving, the system will require the operator to properly identify himself through the validation method/device 104. If the operator is not validated the invention will issue an invalid operator and lock out further attempts. When the incident is detected, this system actives any locator beacons, if they are installed on the vehicle and tied to the invention. Other control modules that depend upon a valid operation will continue to power up and wait for a valid operator. If the valid operator is not detected after a specified amount of time the module will shutdown. While vehicle is in parked state and if the braking system is tied to this invention, this invention will send commands to set brakes and apply park lock.

C. Incident on Low Gear Throttle on Level or Sloped Surface.

If there is an incident while vehicle is at low gear throttle, the system will require the operator to properly identify himself through the validation method/device 104. If the operator is not validated, the system activates locator beacons, if they are installed on the vehicle and tied to the invention. If a system, which controls the engine brake, is tied to this invention, it will bring the throttle down to a specified engine rpm such as idle. When desired engine rpm is reached, the clutch can also be disengaged. The wheel breaks can be applied. If trailer brakes exist, they will be applied first, then cab brakes will be applied until vehicle comes to complete stop. When parked stated is achieved, the brakes and park lock will be applied.

D. Incident at High Gear Throttle on Level or Sloped Surface.

If there is an incident while vehicle is at high gear throttle, the system will require the operator to properly identify himself through the validation method/device 104. If the operator is not validated, the system activates locator beacons, if they are installed on the vehicle and tied to the invention. If the system, which controls the engine brake, is tied to this invention, it will bring the throttle down to a specified engine rpm. When desired engine rpm is achieved, the brakes are applied to slow the speed of the vehicle down. If engine rpm nears stall, the clutch will step down to next lowest gear. This will continue until 1^{st} gear is established where clutch will disengage. The wheel brakes are fully applied. If trailer brakes exist, they will be applied first, then cab brakes will be applied until vehicle comes to complete stop. When parked state is achieved, brakes and park lock will be applied. Each cycle of gear changes will be accomplished within a short period of time, such as 10 seconds, for an unloaded tractor-trailer. If loaded, actual load per axle will determine time per cycle to safely stop the vehicle.

E. Incident at High Gear Throttle on Level or Sloped Surface with Curved Road.

If there is an incident while vehicle is at high gear throttle, the system will require the operator to properly identify himself through the validation method/device 104. If the operator is not validated, the system actives the locator beacons, if they are installed on the vehicle and tied to the invention. If the system, which controls the engine brake, is tied to this invention, it will start to engine brake by bringing the throttle down to a specified engine rpm. When desired engine throttle be achieved, brakes are applied to slow the speed of the vehicle down. If engine rpm nears stall, clutch will step down to next lowest gear. This will continue until 1^{st} gear is established where clutch will disengage. At that point, wheel brakes will be fully applied. If trailer brakes exist, they will be applied first, then cab brakes will be applied until vehicle comes to complete stop. When parked state is achieved, brakes and park lock will be applied. If the wheel vibration is monitored in either front wheel, vehicle will have the tendency to turn away from vibrating wheel through steering wheel control, if connected to the present invention.

### EXAMPLE III

The following examples include crane/crane tower scenarios where normal operation of this vehicle is defined as lift, turn, extend, and drop. Where ranges in control depends upon the lift weight and rate of turn. A third condition is distance of normal load from rotating point. In addition, a system to monitor load, distance from rotation point, and rate of rotation can be implemented to prevent collapse or tipping of vehicle based upon vehicle design.

A. No Incident Operating Situation.

During the operation of this vehicle the said invention will maintain a monitoring mode. If no incident is captured, the invention will not interrupt the normal operation of the vehicle.

B. Incident Prior to Crane Startup.

If there is an incident while vehicle is not in operation, the system will require the operator to properly identify himself through the validation method/device 104. If the operator is not validated prior to startup, the crane will not move, the hook is fully retracted. Extending beams are fully retracted and, if part of a vehicle, the anchoring feet will be fully extended if boom is not in storage position. The system will require the operator to properly identify oneself through the validation method/device 104. If the operator is not validated the invention will resume current state. If a transmitter is connected to the invention, the invalid operator status will activate an emergency beacon. All controls and locks will remain off and locked.

C. Incident while Crane is in Operation with no Load.

If there is an incident while vehicle is in operation with no load, the system will require the operator to properly identify himself through the validation method/device 104. If the operator is not validated, the vehicle will place the vehicle in safe state, where the hook is fully retracted and the boom, if any, is fully retracted. Rotation of the vehicle is slowed down until locked. The rate of rotation is slowed to prevent hook movement. If the operator is validated during the operation, the crane will continue to go to a safe state.

D. Incident while Crane is in Operation with Load.

If there is an incident while vehicle is in operation with a load, the system will require the operator to properly identify himself through the validation method/device 104. If the operator is not validated, the vehicle will place the vehicle in a safe state, where the hook is locked at the current position. If there is rotation, this will be slowed until stopped. If the operator is validated during the operation, the crane will continue to go to a safe state. If the crane is equipped with an auto-release switch, this invention will prevent activation of this release. When all motion stops and locks are placed, the systems will shutdown.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

What is claimed is:

1. An automatic control system for vehicle security for controlling access to the vehicle by an operator during a plurality of different stages of operation of the vehicle, the system comprising:
an operator validity apparatus;
at least one sensor for determining a stage of operation, from the plurality of stages, of the vehicle; and
a vehicle control apparatus for controlling predetermined functions of the vehicle based on outputs from said operator validity apparatus and said stage of operation.

2. The invention of claim 1 wherein said operator validity apparatus comprises a member from the group consisting of a code entry apparatus, a fingerprint recognition apparatus, a voice recognition apparatus and an eye imaging apparatus.

3. The invention of claim 1 wherein said operator validity apparatus comprises periodic prompts to request an operator validity update.

4. The invention of claim 3 wherein said periodic prompts comprise periodic prompts when an operator is invalidated.

5. The invention of claim 1 wherein said operator validity apparatus comprises prompts to request an operator validity update upon performance or non-performance of predetermined maneuvers.

6. The invention of claim 1 wherein said at least one sensor comprises operational sensors.

7. The invention of claim 1 wherein said at least one sensor comprises environmental sensors.

8. The invention of claim 1 wherein said stages of operation comprise a member from the group comprising of vehicle off, vehicle on but not moving, vehicle on and moving, vehicle on and a predetermined function is attempted by the operator and vehicle on and after predetermined time periods.

9. The invention of claim 1 wherein said vehicle control apparatus for controlling predetermined functions comprises an apparatus for automatically triggering a predetermined sequence of controls of the vehicle.

10. A method for controlling access to a vehicle by an invalid operator during a plurality of different stages of operation of the vehicle, the method comprising the steps of:
a) validating the operator;
b) sensing an operational status of the vehicle comprising the plurality of different stages of operation of the vehicle; and
c) controlling predetermined functions of the vehicle if the operator is determined to be invalid and based on a stage of operation, from the plurality of stages of operation, of the vehicle.

11. The method of claim 10 further comprising the step of periodically prompting an operator validity update.

12 The method of claim 11 wherein the step of periodically prompting comprises periodically prompting when the operator is invalidated.

13. The method of claim 10 further comprising the step of requesting an operator validity update upon performance or non-performance of predetermined vehicle maneuvers.

14. The method of claim 10 wherein the step of validating the operator comprises a member from the group consisting of an active validation procedure, a passive validation procedure and a combination active/passive procedure.

15. The method of claim 10 wherein the step of sensing an operational status comprises sensing environmental conditions.

16. The method of claim 10 wherein the step of sensing an operational status comprises sensing vehicle operational conditions.

17. The method of claim 10 wherein the step of controlling predetermined functions of the vehicle comprises automatically triggering a predetermined sequence of controls of the vehicle.
